(19) United States
(12) Patent Application Publication
(10) Pub. No.: US 2026/0251925 A1
(43) Pub. Date: Aug. 27, 2026

(54) OPTICAL MODULATOR STRUCTURES AND METHODS OF FORMING THE SAME

(71) Applicant: Taiwan Semiconductor Manufacturing Co., Ltd., Hsinchu (TW)

(72) Inventors: Ming Yang Jung, Kaohsiung City (TW); Lan-Chou Cho, Hsinchu (TW); You-Cheng Lu, Tainan City (TW); Tai-Chun Huang, New Taipei City (TW); Stefan Rusu, Sunnyvale, CA (US); Ruei-Shen Wang, Hsinchu (TW)

(21) Appl. No.: 19/065,173

(22) Filed: Feb. 27, 2025

(51) Int. Cl. G02F 1/025

(52) U.S. Cl. CPC G02F 1/025

(57) ABSTRACT

A structure includes a first p-type region over a substrate; a second p-type region against the first p-type region, wherein the second p-type region is more heavily doped than the first p-type region; a first n-type region against the first p-type region, wherein a portion of the first n-type region and a portion of the first p-type region collectively form a waveguide region; a second n-type region against the first n-type region, wherein the second n-type region is more heavily doped than the first n-type region; a first conductive oxide layer on the first p-type region; and a second conductive oxide layer on the first n-type region.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical waveguides may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. However, improvements are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1 and 2 are cross-sectional views of intermediate stages in the manufacturing of an optical structure, in accordance with some embodiments.

FIGS. 3, 4, 5, 6, 7, 8, 9, and 10 are cross-sectional views and plan views of intermediate stages in the manufacturing of an optical modulator, in accordance with some embodiments.

FIGS. 12, 13, and 14 are cross-sectional views of phase shifters, in accordance with some embodiments.

FIGS. 15, 16, and 17 are cross-sectional views of intermediate stages in the manufacturing of a phase shifter, in accordance with some embodiments.

FIGS. 18, 19, and 20 are cross-sectional views of phase shifters, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

According to various embodiments, conductive oxide layers are formed on an optical phase shifter to reduce the junction resistance of the optical phase shifter. Reducing the junction resistance can improve the efficiency and the bandwidth of the optical phase shifter. The optical phase shifter may be used as part of an optical modulator, such as a Mach-Zehnder modulator or the like. Various configurations and arrangements of optical phase shifters and optical modulators utilizing conductive oxide layers are described. However, the embodiments presented herein are intended to be illustrative and are not intended to limit the embodiments to the precise descriptions as discussed. Rather, the embodiments discussed may be incorporated into a wide variety of implementations, and all such implementations are fully intended to be included within the scope of the embodiments

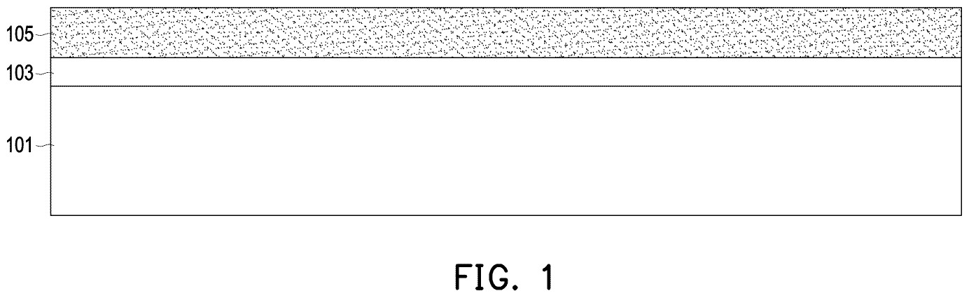

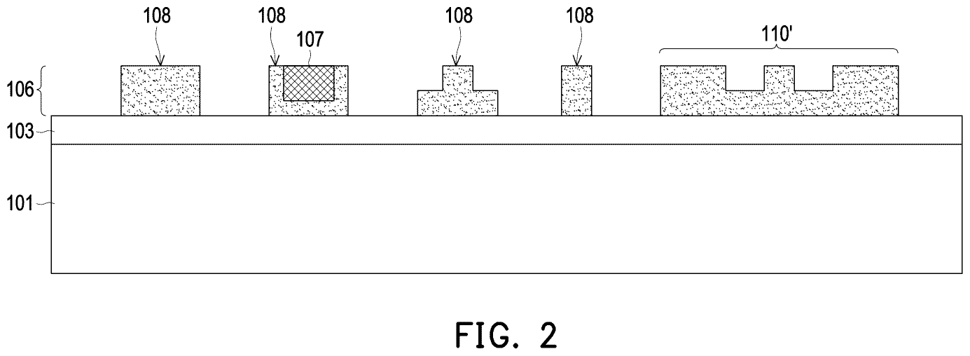

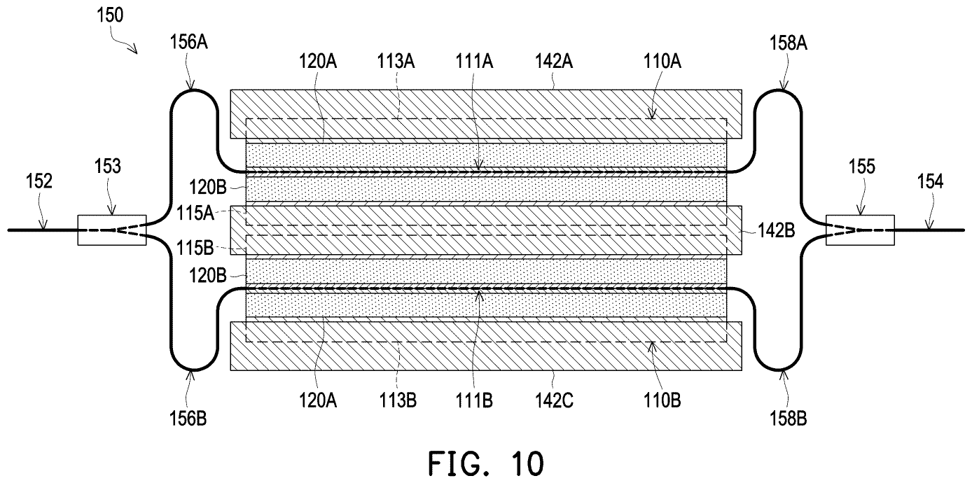

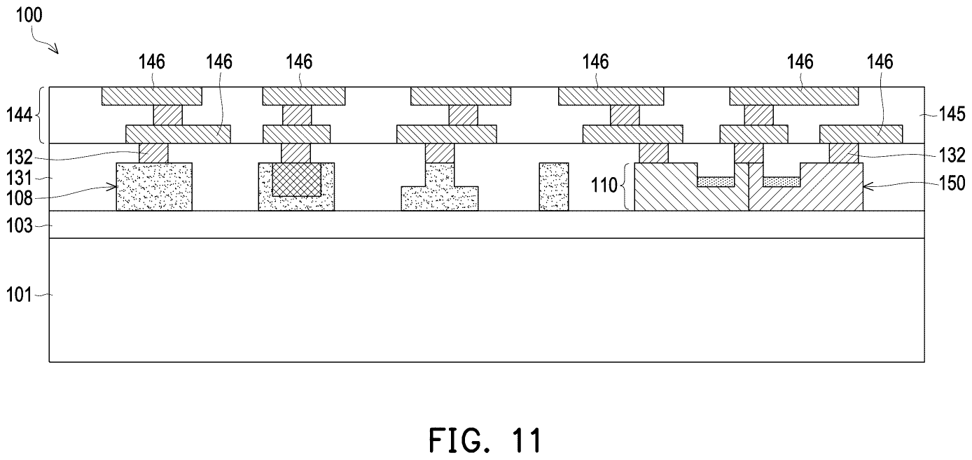

FIGS. 1 through 11 illustrate intermediate stages in the formation of an optical structure 100 (see FIG. 11) comprising an optical modulator 150 (see FIG. 10), in accordance with some embodiments. The optical structure 100 may be part of an optical interposer, a photonic integrated circuit (PIC), an optical engine, and optical device, a photonic package, or the like. FIG. 1 illustrates a cross-sectional view of an initial structure, comprising a first substrate 101, an insulator layer 103, and a layer of material 105 for an active layer 106 of optical components 108 (not separately illustrated in FIG. 1 but illustrated and discussed further below with respect to FIG. 2). In an embodiment, at a beginning of the manufacturing process of the optical structure 100, the first substrate 101, the insulator layer 103, and the layer of material 105 may collectively be part of a silicon-on-insulator (SOI) substrate or the like. In some embodiments, the first substrate 101 may be a semiconductor material such as silicon or germanium, a dielectric material such as glass, or any other suitable material that allows for structural support of overlying devices.

The insulator layer 103 may be a dielectric layer that separates the first substrate 101 from the overlying active layer 106 and can additionally, in some embodiments, serve as a portion of cladding material that surrounds the subsequently manufactured optical components 108 (discussed further below). In some embodiments, the insulator layer 103 may be silicon oxide, silicon nitride, germanium oxide, germanium nitride, combinations of these, or the like. In some embodiments, the insulator layer 103 may be formed using a method such as implantation (e.g., to form a buried oxide (BOX) layer) or may be deposited onto the first substrate 101 using a deposition method such as chemical vapor deposition (CVD), atomic layer deposition (ALD), physical vapor deposition (PVD), combinations of these, or the like. However, any suitable materials or methods of manufacture may be used.

The material 105 for the active layer 106 may initially be formed as a conformal layer of material, in some embodiments. In an embodiment, the material 105 for the active layer 106 may be a suitable material that can be used to form optical components 108 such as waveguides, phase shifters, optical modulators, or other optical components described below. The material 105 may comprise a semiconductor material such as silicon, germanium, silicon germanium, combinations of these, or the like. In other embodiments, the material 105 for the active layer 106 may comprise a dielectric material such as silicon nitride or the like, although in other embodiments the material 105 for the active layer 106 may be III-V materials, lithium niobate materials, polymers, or other suitable materials. In embodiments in which the material 105 of the active layer 106 is deposited, the material 105 for the active layer 106 may be deposited using a method such as epitaxial growth, CVD, ALD, PVD, combinations of these, or the like. In other embodiments in which the insulator layer 103 is formed using an implantation method, the material 105 of the active layer 106 may initially be part of the first substrate 101 prior to the implantation process that forms the first insulation layer 103. However, any suitable materials and methods of manufacture may be utilized to form the material 105 of the active layer 106.

FIG. 2 illustrates an intermediate stage in the formation of optical components 108 from the active layer 106, in accordance with some embodiments. The optical components 108 may include such components as optical waveguides (e.g., ridge waveguides, rib waveguides, buried channel waveguides, diffused waveguides, silicon waveguides, silicon nitride waveguides, etc.), couplers (e.g., grating couplers, edge couplers, evanescent couplers, etc.), directional couplers, optical splitters, optical modulators (e.g., photonic switches, microelectromechanical switches, micro-ring resonators, etc.), phase shifters (e.g., lateral P-N (LPN) phase shifters, vertical P-N (VPN) phase shifters, etc.), amplifiers, multiplexors, demultiplexors, optical-to-electrical converters (e.g., P-N junctions), electrical-to-optical converters, lasers, combinations of these, or the like. However, any suitable optical components 108 may be used.

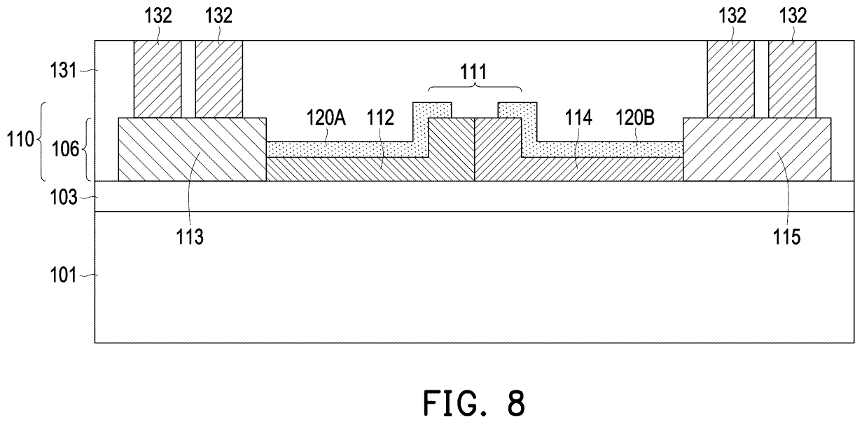

In some embodiments, the optical components 108 include an optical modulator comprising one or more phase shifters. As an example, FIG. 2 illustrates a phase shifter structure 110′ formed as part of a beginning stage of the formation of a phase shifter 110 (see FIG. 8). The resulting phase shifter 110 may be part of an optical modulator 150, in accordance with some embodiments. The phase shifter 110 may be an LPN phase shifter or a VPN phase shifter, and the optical modulator 150 may be a traveling wave Mach-Zehnder interferometer (TWMZM) or the like, described in greater detail below. In some embodiments, an optical modulator 150 includes more than one phase shifter 110.

The optical components 108 of the active layer 106 are manufactured from the material 105, in some embodiments. The active layer 106 may be patterned into the desired shapes for the optical components 203 using, e.g., one or more photolithographic masking and etching processes. However, any suitable method of patterning the material 105 for the active layer 106 may be utilized. For some optical components 108, such as phase shifters 110, additional processing steps are performed after the patterning. In some cases, processing steps such as implantation processes, additional deposition and patterning steps, or the like may be performed before or after patterning the material 105. For example, in some embodiments, a semiconductor material 107 (e.g., germanium or another semiconductor material) may be epitaxially deposited on a patterned portion of the material 105 as part of forming an optical component 108. All such manufacturing processes and all suitable optical components 108 may be manufactured, and all such combinations are fully intended to be included within the scope of the embodiments.

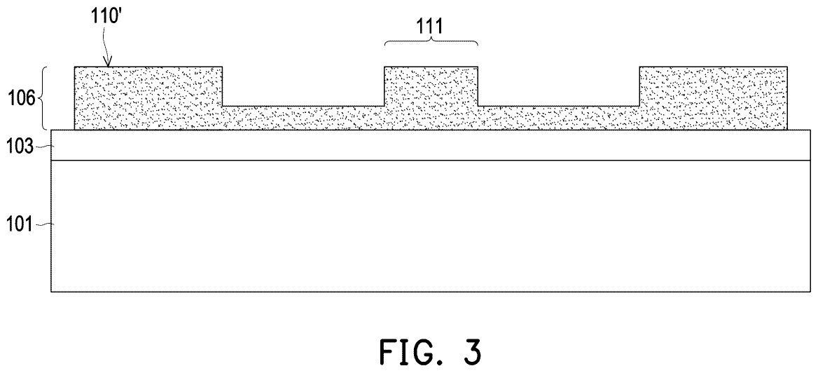

FIGS. 3 through 8 illustrate intermediate stages in the formation of a phase shifter 110, in accordance with some embodiments. FIG. 3 illustrates a magnified view of a phase shifter structure 110′, which may be similar to the phase shifter structure 110′ shown in FIG. 2. For example, the phase shifter structure 110′ shown in FIG. 3 may be part of a beginning stage of the formation of a phase shifter 110, in accordance with some embodiments. The phase shifter structure 110′ comprises a central waveguide region 111 through which optical signals may be transmitted, similar to a waveguide. The waveguide region 111 may be coupled to and/or continuous with waveguides or other optical components 108 formed in the active layer 106.

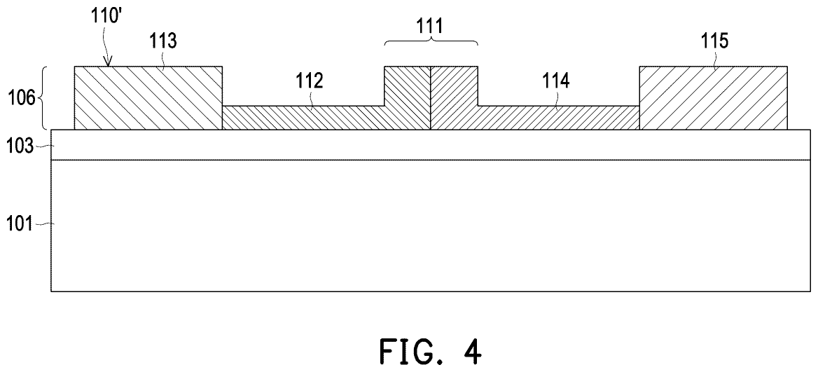

In FIG. 4, one or more implantation processes are performed on the phase shifter structure 110′ to form doped regions, in accordance with some embodiments. For example, in some embodiments, the phase shifter structure 110′ may be implanted with dopants to form doped regions including a first p-type region 112, a second p-type region 113, a first n-type region 114, and a second n-type region 115. The p-type regions 112 and 113 may be doped with suitable p-type dopants such as boron, gallium, or the like. The dopants in the first p-type region 113 may be similar to or different than the dopants in the second p-type region 114. The n-type regions 114 and 115 may be doped with suitable n-type dopants such as phosphorous, arsenic, or the like. The implantation processes associated with the various doped regions may be performed in any suitable order or sequence. The implantation processes may include diffusion processes, and an anneal may be performed to activate the dopants, in some cases.

In some embodiments, the first p-type region 112 may have a dopant concentration in the range of about 10⁹ cm⁻³ to about 10¹⁴ cm⁻³. In some embodiments, the second p-type region 113 may have a doping concentration greater than that of the first p-type region 112, such as a doping concentration in the range of about 10¹⁴ cm⁻³ to about 10²⁰ cm⁻³. In some embodiments, the first n-type region 114 may have a dopant concentration in the range of about 10⁹ cm⁻³ to about 10¹⁴ cm⁻³. In some embodiments, the second n-type region 115 may have a doping concentration greater than that of the first n-type region 114, such as a doping concentration in the range of about 10¹⁴ cm⁻³ to about 10²⁰ cm⁻³. In some cases, the relatively heavier doping of the second p-type region 113 and the second n-type region 115 may facilitate electrical connections, such as electrical connection with contacts 132 (see FIG. 8). Other dopant concentrations or doped regions are possible.

In some embodiments, the first p-type region 112 and the first n-type region 114 form a junction or interface within the waveguide region 111. In this manner, a lateral P-N (LPN) junction is formed within the phase shifter 110, with the p-type regions 112 and 113 and the n-type regions 114 and 115 on opposite sides of the waveguide region 111. Accordingly, the phase shifter 110 may be considered an LPN phase shifter 110. In other embodiments, other shapes of P-N junctions, such as vertical P-N (VPN) junctions, may be formed. In some embodiments, the portions of the first p-type region 112 and the first n-type region 114 within the waveguide region 111 are thicker than the first p-type region 112 and the first n-type region 114 outside of the waveguide region 111. In some embodiments, the second p-type region 113 and the second n-type region 115 are thicker than the portions of the first p-type region 112 and the first n-type region 114 outside of the waveguide region 111. The phase shifter structure 110′ and doped regions therein may have other sizes or dimensions (e.g., lengths, widths, thicknesses, etc.), and other configurations or arrangements are possible.

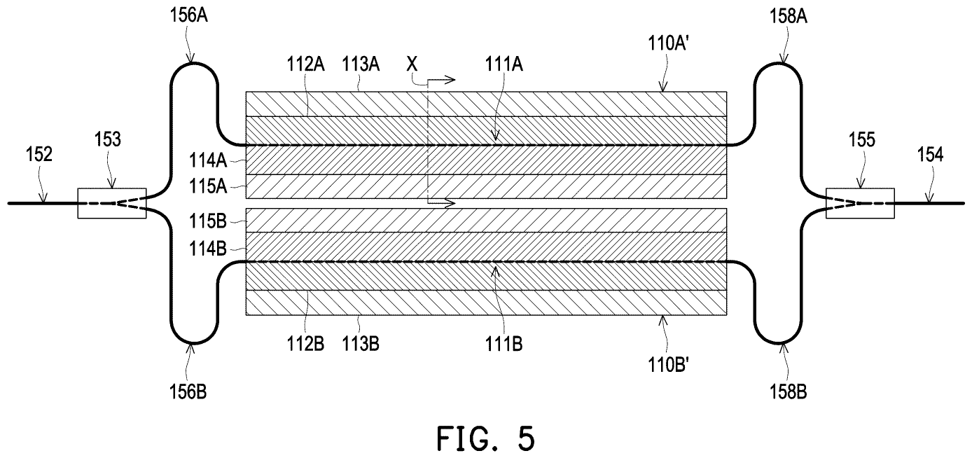

FIG. 5 illustrates a plan view of an intermediate stage in the formation of an optical modulator 150, in accordance with some embodiments. The structure shown in FIG. 5 includes two phase shifter structures 110A′ and 110B′, each of which may be similar to the phase shifter structure 110′ shown in FIG. 4. For example, the phase shifter structure 110A′ includes p-type regions 112A and 113A on one side of a waveguide region 111A, and n-type regions 114A and 115A on the opposite side of the waveguide region 111A. Similarly, the phase shifter structure 110B′ includes p-type regions 112B and 113B on one side of a waveguide region 111B, and n-type regions 114B and 115B on the opposite side of the waveguide region 111B. The cross-sectional view of FIG. 4 may be along a cross-section similar to the reference cross-section X indicated in FIG. 5, in some cases. Other configurations or arrangements of doped regions are possible. For example, in other embodiments, both second n-type regions 115A and 115B may be portions of a single heavily-doped n-type region. The phase shifter structure 110A′ is subsequently processed to form a phase shifter 110A, and the phase shifter structure 110B′ is subsequently processed to form a phase shifter 110B. Both phase shifters 110A and 110B are part of the subsequently formed optical modulator 150.

The waveguide region 111A is optically coupled to a first waveguide 156A and a second waveguide 158A such that optical signals may be transmitted from the first waveguide 156A, through the waveguide region 111A, and into the second waveguide 158A. The waveguide region 111B is optically coupled to a first waveguide 156B and a second waveguide 158B such that optical signals may be transmitted from the first waveguide 156B, through the waveguide region 111B, and into the second waveguide 158B. Optical signals may also be transmitted in the opposite direction through the phase shifter 110A or through the phase shifter 110B. The first waveguides 156A-B may be optically coupled to a waveguide 152 by a first splitter 153, and the second waveguides 158A-B may be optically coupled to a waveguide 154 by a second splitter 155. The first splitter 153 may be configured to split optical signals from the waveguide 152 into the first waveguides 156A-B and/or to combine optical signals from the first waveguides 156A-B into the waveguide 152. Similarly, the second splitter 155 may be configured to split optical signals from the waveguide 154 into the second waveguides 158A-B and/or to combine optical signals from the second waveguides 158A-B into the waveguide 154. In this manner, an optical signal in the waveguide 152 may be split between the first waveguides 156A-B, transmitted through the waveguide regions 111A-B of the phase shifters 110A-B and into the second waveguides 158A-B, and combined by the second splitter 155 into the waveguide 154. Optical signals in the waveguide 154 may also be similarly transmitted in the opposite direction. The waveguides 152, 154, 156A-B, and 158-B may be formed in the active layer 106, and may be similar to waveguides described previously for FIG. 2.

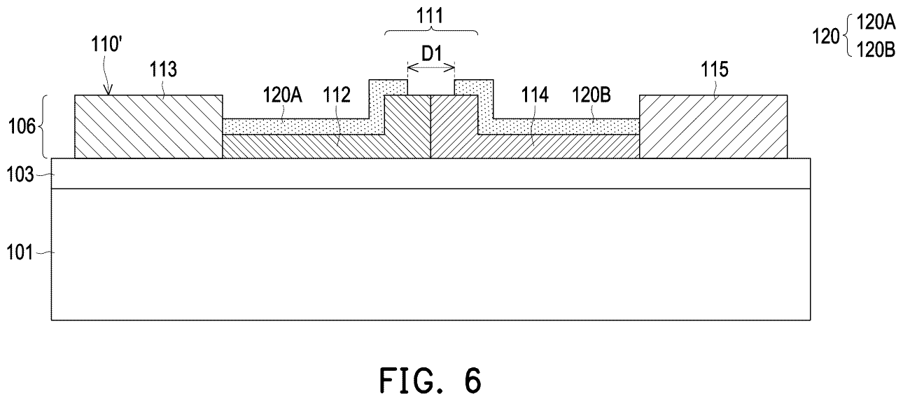

In FIG. 6, conductive oxide layers 120 are formed over the phase shifter structure 110′, in accordance with some embodiments. The conductive oxide layers 120 may comprise separate regions of conductive oxide material, such as the first conductive oxide layer 120A and the second conductive oxide layer 120B illustrated in FIG. 6. Accordingly, “conductive oxide layers 120” may collectively refer to the conductive oxide layers 120A-B and/or other separate conductive oxide layers formed on the structure. In some embodiments, the conductive oxide layers 120 comprise a material such as indium tin oxide (ITO), strontium titanate (SrTiO₃), barium titanate (BaTiO₃), zinc oxide (ZnO), copper oxide (CuO), nickel oxide (NiO), hydrogen-doped indium oxide (IHO), another metal oxide, combinations thereof, multilayers thereof, or the like. The conductive oxide layers 120 may have a thickness in the range of about 1 nm to about 500 nm, though other thicknesses are possible. The conductive oxide layers 120 may be deposited using suitable techniques, such as CVD, ALD, PVD, or the like. In some cases, forming conductive oxide layers 120 on the phase shifter structure 110′ can reduce resistance across the resulting phase shifter 110, such as reducing junction resistance between the first p-type region 112 and the first n-type region 114. Reducing resistance in the phase shifters 110 by utilizing conductive oxide layers 120 as described herein can improve bandwidth and efficiency of the optical modulator 150.

In some embodiments, the conductive oxide layers 120 are formed as a first conductive oxide layer 120A formed over the p-type regions 112 and/or 113, and a second conductive oxide layer 120B formed over the n-type regions 114 and/or 115. In some embodiments, the conductive oxide layers 120 are initially formed as a conformal layer of conductive oxide material deposited over the phase shifter structure 110′, which is then patterned to form separate regions of conductive oxide material (e.g., the conductive oxide layers 120A-B). The conductive oxide layers 120 may be patterned using suitable photolithography and etching techniques. In other embodiments, a mask layer (e.g., a photoresist, polymer, hard mask, etc.) may be deposited on the phase shifter structure 110′ and patterned to form openings, and the conductive oxide material may be deposited over the mask layer and within the openings. The mask layer may then be removed, with the remaining portions of the conductive oxide material forming the separate regions of the conductive oxide layer 120. In this manner, multiple conductive oxide layers 120 may be formed using a single deposition step. Other techniques for forming separate conductive oxide layers 120 are possible. In other embodiments, more than two separate conductive oxide layers 120 may be formed.

In the embodiment of FIG. 6, the first conductive oxide layer 120A extends over the first p-type region 112 from the second p-type region 113 to the waveguide region 111, and the second conductive oxide layer 120B extends over the first n-type region 114 from the second n-type region 115 to the waveguide region 111. The first conductive oxide layer 120A may or may not directly (e.g., physically) contact a sidewall of the second p-type region 113, and the second conductive oxide layer 120B may or may not directly contact a sidewall of the second n-type region 115. As shown in FIG. 6, the conductive oxide layers 120A-B may extend on sidewalls of the waveguide region 111, and may extend on top surfaces of the waveguide region 111. In other embodiments, the conductive oxide layers 120A-B may not extend on sidewalls and/or top surfaces of the waveguide region 111. In some embodiments, top surfaces of the first p-type region 112 and the first n-type region 114 within the waveguide region 111 may be exposed. In some embodiments, a distance D1 between the first conductive oxide layer 120A on the first p-type region 112 and the second conductive oxide layer 120B on the first n-type region 114 is in the range of about 1 nm to about 100 μm, though other distances are possible.

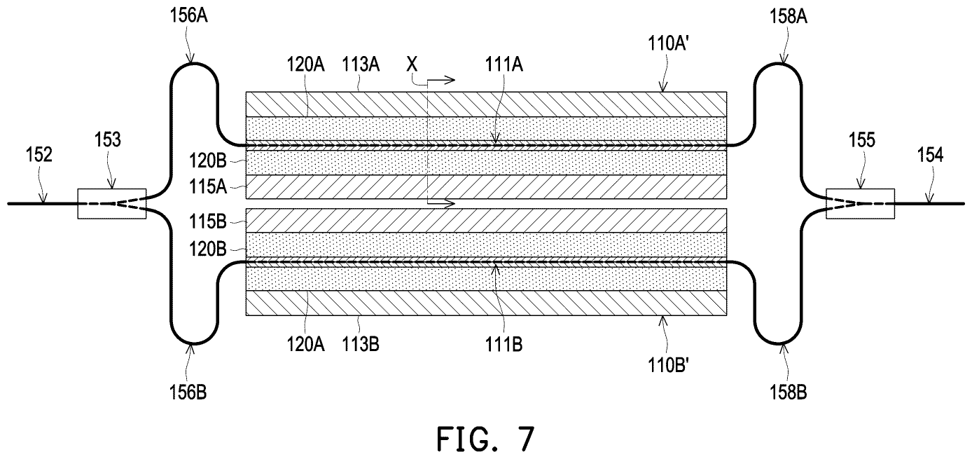

FIG. 7 illustrates a plan view of an intermediate stage in the formation of an optical modulator 150, in accordance with some embodiments. The plan view shown in FIG. 7 is similar to the plan view of FIG. 5, and FIG. 7 illustrates the structure of FIG. 5 after conductive oxide layers 120 have been formed. The phase shifter structures 110A′ and 110B′ of FIG. 7 are similar to the phase shifter structure 110′ of FIG. 6. Accordingly, the cross-sectional view of FIG. 6 may be along a cross-section similar to the reference cross-section X indicated in FIG. 7. For example, conductive oxide layers 120A-B are formed on the first phase shifter structure 110A′, and conductive oxide layers 120A-B are formed on the second phase shifter structure 110B′. As shown in FIG. 7, the conductive oxide layers 120 may extend along the length of a phase shifter structure 110′.

In FIG. 8, contacts 132 are formed to make electrical connections to the second p-type region 113 and the second n-type region 115, in accordance with some embodiments. In this manner, a phase shifter 110 is formed from the phase shifter structure 110′. One or more contacts 132 may be formed on the second p-type region 113 and the second n-type region 115 to make physical and electrical connections to the phase shifter 110. In other embodiments, contacts 132 may make physical and electrical connections to the conductive oxide layers 120. In some embodiments, a dielectric material 131 is deposited over the phase shifter structure 110′, and the contacts 132 are formed to extend through the dielectric material 131. In some cases, the dielectric material 131 is deposited over the other optical components 108 of the active layer 106, and additional contacts may be formed through the dielectric material 131 to make physical and electrical connections to some other optical components 108. In some cases, the dielectric material 131 acts as part of a cladding layer for a phase shifter 110, an optical modulator 150, and/or other optical components 108.

In some embodiments, the dielectric material 131 may be a dielectric material such as silicon oxide, or a low-k dielectric material such as silicon oxynitride, combinations of these, or the like, deposited using a deposition process such as CVD, ALD, PVD, combinations of these, or the like. However, any suitable materials and manufacturing processes may be utilized. In some cases, a planarization process, such as a CMP process and/or a grinding process, may be performed to remove excess upper material of the dielectric material 131. After forming the dielectric material 131, openings may be patterned in the dielectric material 131 that expose surfaces of the second p-type region 113 and the second n-type region 115. The openings may be patterned using suitable photolithography and etching techniques. Conductive material(s) may then be deposited in the openings to form the contacts 132. In some embodiments, the conductive materials comprise an optional liner layer and a conductive fill material. The optional liner layer may include, for example, a barrier layer, a diffusion layer, an adhesion layer, or the like. The conductive fill material may comprise, for example, a metal or a metal alloy such as copper, silver, gold, tungsten, cobalt, ruthenium, aluminum, alloys thereof, combinations thereof, or the like. The conductive material(s) of the contacts 132 may be deposited using suitable techniques, such as CVD, ALD, PVD, plating, sputtering, or the like. However, any suitable materials and manufacturing processes may be utilized. In some cases, a planarization process, such as a CMP process and/or a grinding process, may be performed to remove excess upper conductive material(s) of the contacts 132 from top surfaces of the dielectric material 131.

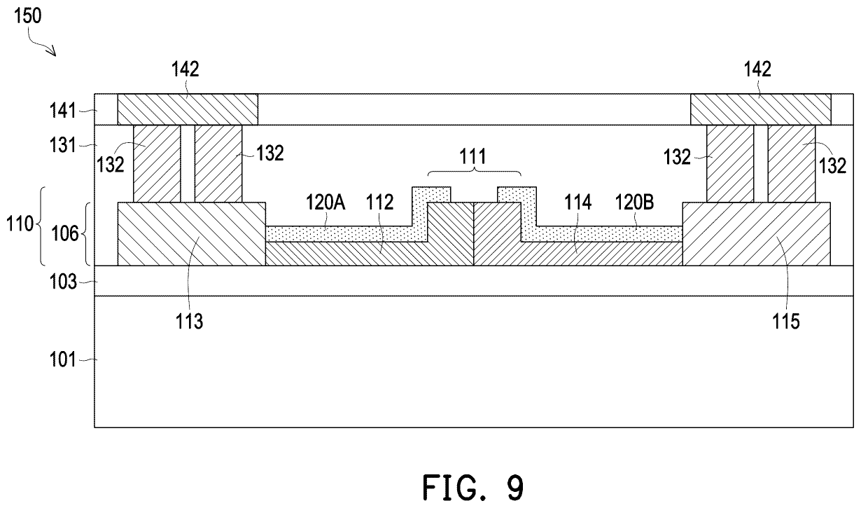

In FIG. 9, conductive lines 142 are formed over the phase shifter 110, forming an optical modulator 150, in accordance with some embodiments. The conductive lines 142 are formed on the contacts 132 and make physical and electrical connections to the contacts 132. In this manner, the conductive lines 142 electrically connect the phase shifter(s) 110 and the optical modulator 150, and allow the optical modulator 150 to be operated using electrical signals. The conductive lines 142 may comprise, for example, metal lines, conductive vias, redistribution layers, metallization layers, or the like. The conductive lines 142 may be part of an interconnect structure, such as the interconnect structure 144 described below for FIG. 11. Accordingly, additional conductive lines or other conductive features may be formed over the conductive lines 142, and may form additional electrical interconnections. In some embodiments, the conductive lines 142 are formed in a dielectric layer 141.

The conductive lines 142 may be formed using any suitable processes such as deposition, plating, damascene, dual damascene, or the like. The dielectric layer 141 may be, for example, an insulating layer and/or a passivating layer, and may comprise silicon oxide, silicon nitride, a polymer, a molding material, the like, or a combination thereof. The dielectric layer 141 may be deposited over the dielectric material 131 using a suitable deposition process. The conductive lines 142 may be formed, for example, of a metal or a metal alloy such as copper, silver, gold, tungsten, cobalt, ruthenium, aluminum, alloys thereof, combinations thereof, or the like. Other materials or formation techniques are possible.

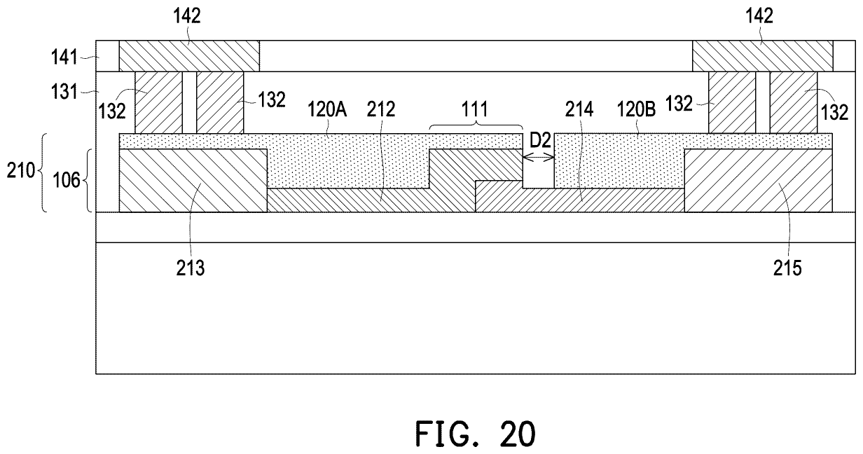

FIG. 10 illustrates a plan view of an optical modulator 150, in accordance with some embodiments. The plan view shown in FIG. 10 is similar to the plan view of FIG. 7. The phase shifters 110A and 110B of FIG. 10 are similar to the phase shifter 110 of FIG. 9. The optical modulator 150 includes three conductive lines 142, indicated as conductive lines 142A-C. As shown in FIG. 20, the conductive lines 142A-C extend along the length of a phase shifters 110A-B. The conductive line 142A is connected to the first p-type region 113A of the first phase shifter 110A by contacts 132 (not illustrated in FIG. 10), the conductive line 142C is connected to the first p-type region 113B of the second phase shifter 110B by contacts 132, and the conductive line 142B is connected to the second n-type regions 115A-B of the phase shifters 110A-B by contacts 132. The optical modulator 150 shown in FIG. 10 is an example, and other arrangements or configurations are possible.

The following description considers the optical modulator 150 modulating an input optical signal provided to the waveguide 152, with the modulated output optical signal resulting at the waveguide 154. In other cases, the optical modulator 150 may receive input optical signals at the waveguide 154 and provide the modulated output optical signals to the waveguide 152. The input optical signals may be modulated optical signals or may be a constant signal (e.g., a source of optical power). An input optical signal may be split by the first splitter 153 such that the signal is transmitted into both waveguide regions 111A-B. In operation, electrical signals (e.g., voltage signals, current signals, voltage pulses, RF signals, microwave transmission signals, or the like) are applied to the conductive lines 142A-C to form a bias across the first phase shifter 110A and/or across the second phase shifter 110B. In some cases, the conductive line 142B may be connected to a ground, with electrical signals applied to the conductive line 142A and the conductive line 142C. Other electrical configurations are possible.

The electrical signals applied to the conductive lines 142A-C bias the P-N junction in the waveguide region 111A of the first phase shifter 110A and/or the P-N junction in the waveguide region 111B of the second phase shifter 110B. Biasing the P-N junctions of a waveguide region 111 can change the optical properties of the waveguide region 111, such as the refractive index. For example, reverse-biasing the P-N junction of a waveguide region 111 can cause the carrier concentration in the waveguide region 111 to decrease, which can cause the refractive index of the waveguide region 111 to increase. The phase of an optical signal within a waveguide region 111 can be controlled by controlling the refractive index within the waveguide region 111, and the refractive index within the waveguide region 111 can be controlled by controlling the bias (e.g., controlling the carrier distribution) across the P-N junction of the waveguide region 111 using electrical signals. In this manner, electrical signals applied to the P-N junctions of the phase shifters 110A-B can shift the phase of the optical signals within the waveguide regions 111A-B, and the optical signals in the first phase shifter 110A may be phase-shifted relative to the optical signals in the second phase shifter 110B. When the two optical signals in the phase shifters 110A-B are recombined at the second splitter 155, the two optical signals constructively interfere or destructively interfere according to the phase difference between them. Thus, the output optical signal in the second waveguide 154 can be an optical signal that is modulated by controlling the phases of the optical signals within the phase shifters 110A-B. In this manner, the optical modulator 150 may be considered a traveling wave Mach-Zehnder interferometer (TWMZM) or the like.

In some cases, lowering the resistance across a phase shifter 110 can improve the bandwidth of the phase shifter 110 and can reduce the transmission loss of the electrical signals within the phase shifter 110. For example, reducing the junction resistance of the P-N junction within a phase shifter 110 can improve efficiency and operating speed. The use of conductive oxide layers 120 as described herein can lower the resistance across a phase shifter 110, and thus improve operation of the phase shifter 110 and improve operation of structures that incorporate a phase shifter 110 such as an optical modulator 150. The conductive oxide layers 120 described herein can allow for a reduction in resistance of a phase shifter 110 without creating significant parasitic capacitances within the phase shifter 110. In some embodiments, the conductive oxide layers 120 may allow for greater control of electric fields within a phase shifter 110 and allow for more efficient control of the carrier distribution (e.g., carrier depletion or carrier accumulation) within the waveguide region 111 of a phase shifter 110.

Additional processing may be performed on an optical modulator 150. As an example, FIG. 11 illustrates a cross-section of an intermediate stage in the formation of an optical structure 100, in accordance with some embodiments. The cross-section of FIG. 11 is similar to the cross-section of FIG. 1. For example, the optical structure 100 of FIG. 11 includes multiple optical components 108 and an optical modulator 150. A shown in FIG. 11, the dielectric material 131 may be formed over the optical components 108, and contacts 132 may be formed within the dielectric material 131. An interconnect structure 14o is formed over the optical components 108, and makes electrical interconnections within the optical structure 100, including electrical connections to optical components 108. The interconnect structure 144 includes dielectric layers 145 (not individually illustrated) with conductive features 146 formed in the dielectric layers 145, in some embodiments. The conductive features 146 may comprise conductive lines, conductive vias, conductive pads, metallization patterns, redistribution layers, or the like. The conductive features 146 may be similar to the conductive lines 142 described for FIGS. 9-10, and may include the conductive lines 142 described for FIGS. 9-10. The dielectric layers 145 may be similar to the dielectric layer 141 described for FIGS. 9-10, and may include the dielectric layer 141 described for FIGS. 9-10.

In some embodiments, the interconnect structure 144 is formed of alternating layers of dielectric material (e.g., dielectric layers 145) and conductive material (e.g., conductive features 146). The conductive features 146 may be formed using any suitable processes such as deposition, damascene, dual damascene, or the like. In particular embodiments, the interconnect structure 144 may have multiple layers of conductive features 146, but the precise number of layers of conductive features 146 may be dependent upon the design of the optical structure 100. The dielectric layers 145 may be, for example, insulating layers and/or passivating layers, and may comprise silicon oxide, silicon nitride, a polymer, a molding material, the like, or a combination thereof. The conductive features 146 may include, for example, a metal or a metal alloy such as copper, silver, gold, tungsten, cobalt, ruthenium, aluminum, alloys thereof, combinations thereof, or the like. Other materials or formation techniques are possible. The optical structure 100 shown in FIG. 11 is an example, and other configurations or arrangements are possible, and additional processing steps may be performed subsequent to the structure shown in FIG. 11.

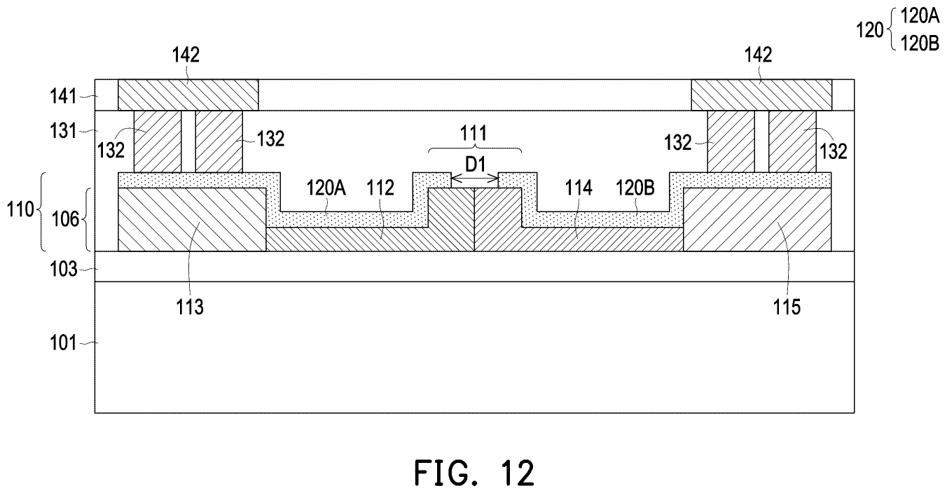

The phase shifter 110 shown previously in FIG. 9 is an example, and other configurations of the conductive oxide layers 120 of a phase shifter 110 are possible. As a set of non-limiting examples, FIGS. 12-14 illustrate cross-sectional views of phase shifters 110 similar to that shown in FIG. 9, except having a different configuration of conductive oxide layers 120. The phase shifters 110 of FIGS. 12-14 may be formed using similar materials or techniques as described above for the phase shifter 110 of FIG. 9. For example, the phase shifters 110 in FIGS. 12-14 are Lateral P-N (LPN) phase shifters that may be incorporated into an optical modulator, such the optical modulator 150 described previously. Other configurations or arrangements of conductive oxide layers 120 are possible and all such variations are considered within the scope of the present disclosure.

The phase shifter 110 of FIG. 12 is similar to that shown in FIG. 9, except that the conductive oxide layers 120 are also deposited on the second p-type region 113 and the second n-type region 115. The contacts 132 may be formed to physically and electrically connect to the conductive oxide layers 120. For example, the first conductive oxide layer 120A may extend continuously from a top surface of the second p-type region 113 to a top surface of the first p-type region 112 in the waveguide region 111, and the second conductive oxide layer 120B may extend continuously from a top surface of the second n-type region 115 to a top surface of the first n-type region 114 in the waveguide region 111. Accordingly, the first conductive oxide layer 120A may extend on top surfaces and sidewall surfaces of the second p-type region 113, and the second conductive oxide layer 120B may extend on top surfaces and sidewall surfaces of the second n-type region 115. In some embodiments, a distance D1 between the first conductive oxide layer 120A on the first p-type region 112 and the second conductive oxide layer 120B on the first n-type region 114 is in the range of about 1 nm to about 100 μm, though other distances are possible. Forming conductive oxide layers 120 on the higher-doped regions of a phase shifter 110 and/or forming the contacts 132 on the conductive oxide layers 120 may allow for reduced resistance and improved control of the carrier distribution within the waveguide region 111. In some cases, forming the conductive oxide layers 120 over a larger surface area can reduce resistance of a phase shifter 110.

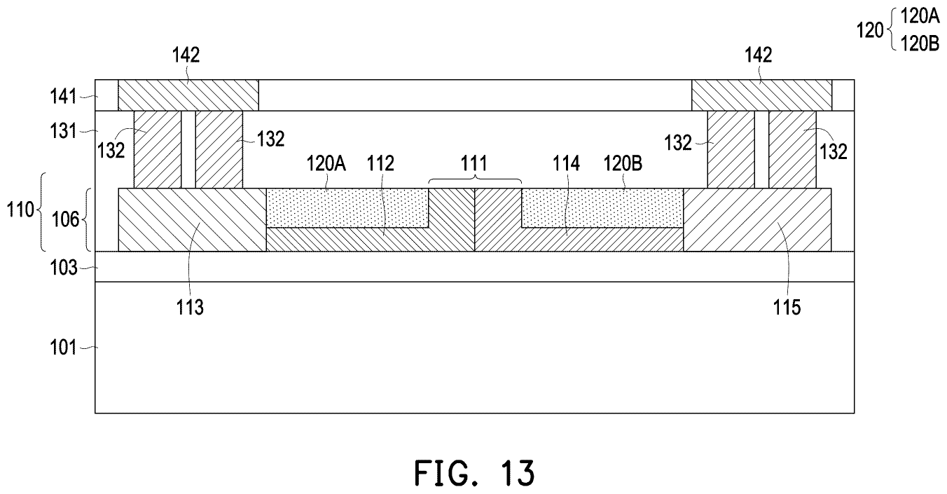

The phase shifter 110 of FIG. 13 is similar to that shown in FIG. 9, except that the conductive oxide layers 120 are deposited to at least partially fill the region between the second p-type region 113 and the waveguide region 111, and between the second n-type region 115 and the waveguide region 111. In some embodiments, top surfaces of the waveguide region 111 may be free of the conductive oxide layers 120. Top surfaces of the p-type regions 112 and 113, top surfaces of the n-type regions 114 and 115, and/or top surfaces of the conductive oxide layers 120 may have similar or different heights above the insulator layer 103. For example, in some embodiments, top surfaces of the p-type regions 112 and 113, top surfaces of the n-type regions 114 and 115, and/or top surfaces of the conductive oxide layers 120A-B may be approximately level or coplanar, as shown in FIG. 13. Sidewalls of the conductive oxide layers 120 may or may not physically (e.g., directly) contact sidewalls of the second p-type region 113, the second n-type region 115, and/or the waveguide region 111. In some cases, forming conductive oxide layers 120 having a greater thickness can reduce resistance of a phase shifter 110.

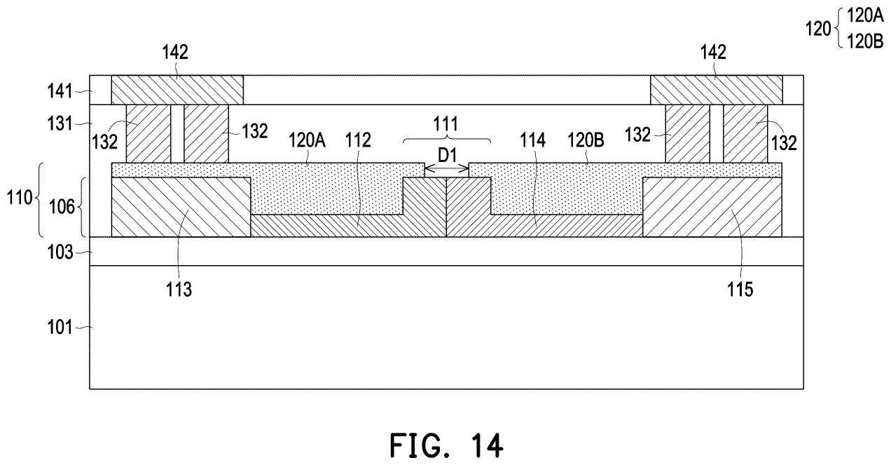

The phase shifter 110 of FIG. 14 is similar to that shown in FIG. 13 except that the conductive oxide layers 120 are also deposited on top surfaces of the second p-type region 113, the second n-type region 115, and/or the waveguide region 111. In other embodiments, top surfaces of the waveguide region 111 may be free of the conductive oxide layers 120. In some embodiments, top surfaces of the conductive oxide layers 120 may be approximately coplanar or level. In some embodiments, a distance D1 between the first conductive oxide layer 120A on the first p-type region 112 and the second conductive oxide layer 120B on the first n-type region 114 is in the range of about 1 nm to about 100 μm, though other distances are possible. In some cases, forming conductive oxide layers 120 over a larger surface area and having a greater thickness can reduce resistance of a phase shifter 110.

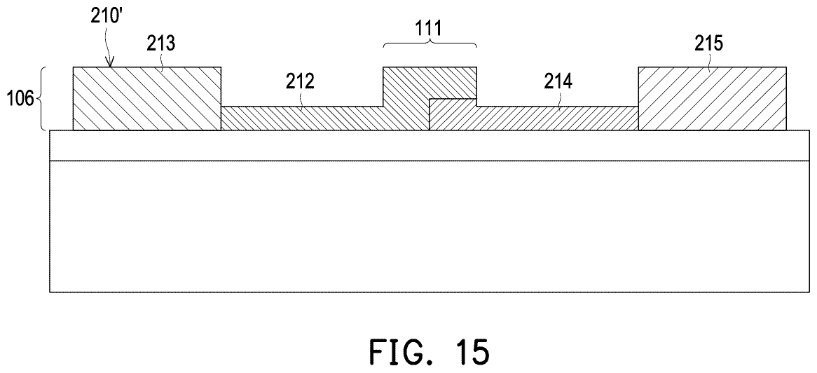

FIGS. 15-17 illustrate intermediate stages in the formation of a phase shifter 210, in accordance with some embodiments. The phase shifter 210 is similar to the phase shifter 110 described for FIGS. 9 and 12-14, except that the phase shifter 210 includes a first p-type region 212 that extends over a first n-type region 214 in the waveguide region 111. In this manner, a vertical P-N (VPN) junction is formed within the phase shifter 210, and the phase shifter 210 may be considered a VPN phase shifter. The phase shifter 210 may be formed using similar materials and techniques as the phase shifter 110, and some details may not be repeated. FIG. 15 illustrates a phase shifter structure 210′, in accordance with some embodiments. The phase shifter structure 210′ is similar to the phase shifter structure 110′ described for FIG. 4, except for the configuration of the doped region. The phase shifter structure 210′ may be formed using implantation processes, dopants, and/or doping concentrations similar to those described previously for FIG. 4. The implantation processes form a first p-type region 212, a second p-type region 213, a first n-type region 214, and a second n-type region 215. The second p-type region 213 may have a higher doping concentration than the first p-type region 212, and the second n-type region 215 may have a higher doping concentration than the first n-type region 214. The first p-type region 212 and the first n-type region 214 extend into the waveguide region 111 of the phase shifter 210.

As shown in FIG. 15, the implantation processes are controlled such that the first p-type region 212 extends over the first n-type region 214 in the waveguide region 111. The first p-type region 212 may extend partially or fully over the first n-type region 214 in the waveguide region 111. Accordingly, the first p-type region 212 may extend fully across the waveguide region 111, in some embodiments. Forming the doped regions in a VPN configuration can form a P-N junction having a larger interface area (e.g., than a lateral P-N junction). In some cases, a larger interface area of a P-N junction can allow for greater control over the carrier distribution during operation of the phase shifter. The area of the P-N junction in a phase shifter can be controlled by controlling the sizes or shapes of the first p-type region 212 and the first n-type region 214 using appropriate implantation processes. In this manner, a phase shifter may be formed having particular P-N junction characteristics, allowing for greater flexibility of design and greater flexibility of phase shifter operation. In other embodiments, the first n-type region 214 may extend over the first p-type region 212 in the waveguide region 111.

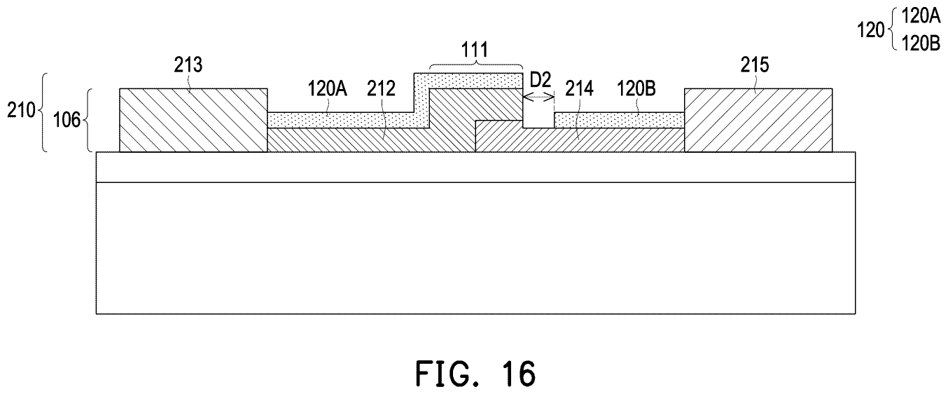

In FIG. 16, conductive oxide layers 120 are formed over the phase shifter structure 210′, in accordance with some embodiments. The conductive oxide layers 120 may be similar to the conductive oxide layers described previously for FIG. 6, and may be formed using similar techniques. For example, a first conductive oxide layer 120A may be formed over the first p-type region 212, and a second conductive oxide layer 120B may be formed over the first n-type region 214. In some embodiments, the first conductive oxide layer 120A may extend fully or partially over the top surface of the waveguide region 111. In other embodiments, sidewalls and/or top surfaces of the waveguide region 111 may be free of the conductive oxide layer 120A. The first conductive oxide layer 120A may or may not directly (e.g., physically) contact a sidewall of the second p-type region 213, and the second conductive oxide layer 120B may or may not directly contact a sidewall of the second n-type region 215. In some embodiments, a distance D2 between the second conductive oxide layer 120B and the waveguide region 111 is in the range of about 1 nm to about 100 μm, though other distances are possible.

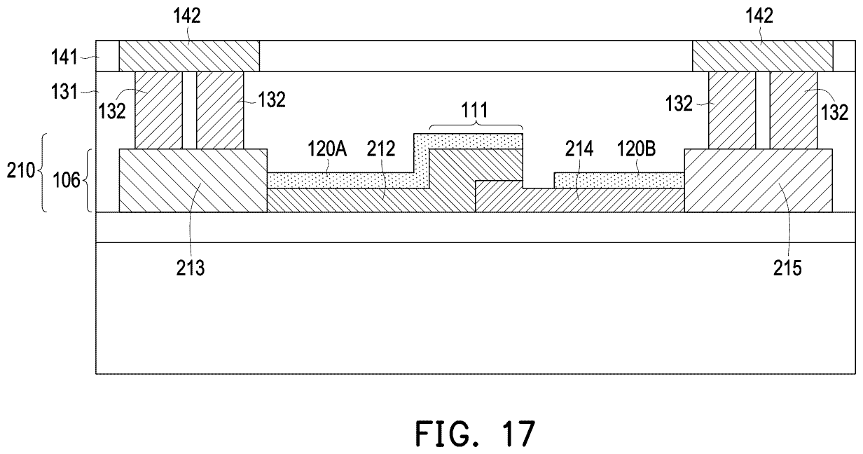

In FIG. 17, contacts 132 and conductive lines 142 are formed, in accordance with some embodiments. The contacts 132 and conductive lines 142 may be similar to those described previously for FIGS. 8-9, and may be formed using similar techniques. For example, a dielectric material 131 may be formed over the structure, and then contacts 132 may be formed extending through the dielectric material 131 to electrically connect the second p-type region 213 and the second n-type region 215. The conductive lines 142 may be electrically connected to the contacts 132, and may be formed in a dielectric layer 141. The conductive lines 142 and dielectric layer 141 may be part of an interconnect structure or the like. In this manner, a VPN phase shifter 210 may be formed.

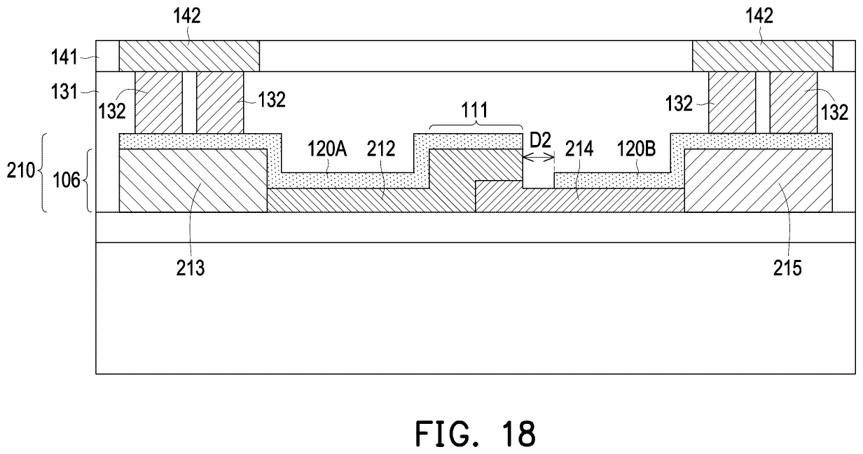

The VPN phase shifter 110 shown previously in FIG. 17 is an example, and other configurations of the conductive oxide layers 120 of a VPN phase shifter 210 are possible. As a set of non-limiting examples, FIGS. 18-20 illustrate cross-sectional views of phase shifters 210 similar to that shown in FIG. 17, except having a different configuration of conductive oxide layers 120. The phase shifters 210 of FIGS. 18-20 may be formed using similar materials or techniques as described above for the phase shifter 110 of FIG. 9 or the phase shifter 210 of FIG. 17. For example, the phase shifters 210 in FIGS. 18-20 may be incorporated into an optical modulator, such the optical modulator 150 described previously. Other configurations or arrangements of conductive oxide layers 120 are possible and all such variations are considered within the scope of the present disclosure.

The phase shifter 210 of FIG. 18 is similar to that shown in FIG. 17, except that the conductive oxide layers 120 are also deposited on the second p-type region 213 and the second n-type region 215. In this manner, the phase shifter 210 of FIG. 18 may be similar to the phase shifter 110 of FIG. 12. The contacts 132 may be formed to physically and electrically connect to the conductive oxide layers 120. For example, the first conductive oxide layer 120A may extend continuously from a top surface of the second p-type region 213 to a top surface of the waveguide region 111, and the second conductive oxide layer 120B may extend continuously from a top surface of the second n-type region 115 to a top surface of the first n-type region 114. In some embodiments, a distance D2 between the second conductive oxide layer 120B and the waveguide region 111 is in the range of about 1 nm to about 100μm, though other distances are possible. Forming conductive oxide layers 120 on the higher-doped regions of a phase shifter 210 and/or forming the contacts 132 on the conductive oxide layers 120 may allow for reduced resistance and improved control of the carrier distribution within the waveguide region 111. In some cases, forming the conductive oxide layers 120 over a larger surface area can reduce resistance of a phase shifter 210.

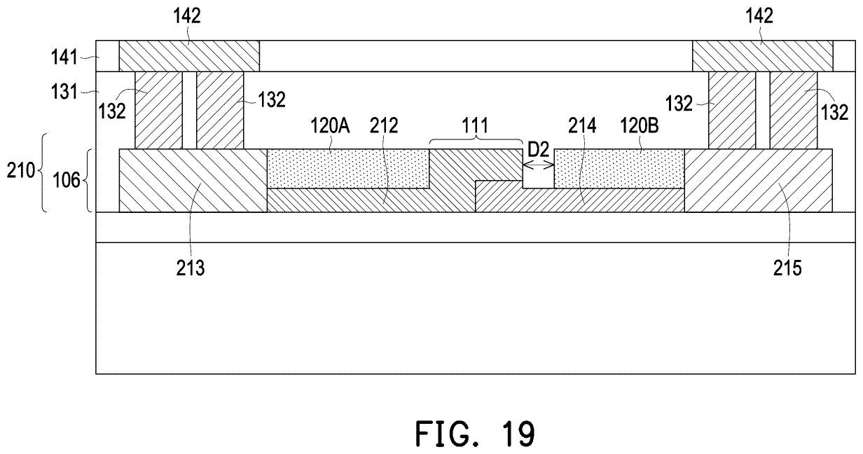

The phase shifter 210 of FIG. 19 is similar to that shown in FIG. 17, except that the conductive oxide layers 120 are deposited to at least partially fill the region between the second p-type region 113 and the waveguide region 111, and between the second n-type region 115 and the waveguide region 111. As shown in FIG. 19, the second conductive oxide layer 120B is separated from the waveguide region 111 by a distance D2 in the range of about 1 nm to about 100 μm, though other distances are possible. The phase shifter 210 of FIG. 19 may be similar to the phase shifter 110 of FIG. 13. In some embodiments, top surfaces of the waveguide region 111 may be free of the conductive oxide layers 120. Top surfaces of the p-type regions 212 and 213, top surfaces of the n-type regions 214 and 215, and/or top surfaces of the conductive oxide layers 120 may have similar or different heights above the insulator layer 103. For example, in some embodiments, top surfaces of the p-type regions 212 and 213, top surfaces of the n-type regions 214 and 215, and/or top surfaces of the conductive oxide layers 120A-B may be approximately level or coplanar, as shown in FIG. 19. Sidewalls of the conductive oxide layers 120 may or may not physically (e.g., directly) contact sidewalls of the second p-type region 213, the second n-type region 215, and/or the waveguide region 111. In some cases, forming conductive oxide layers 120 having a greater thickness can reduce resistance of a phase shifter 110.

The phase shifter 210 of FIG. 20 is similar to that shown in FIG. 19 except that the conductive oxide layers 120 are also deposited on top surfaces of the second p-type region 213, the second n-type region 215, and/or the waveguide region 111. The phase shifter 210 of FIG. 20 may be similar to the phase shifter 110 of FIG. 14. In other embodiments, top surfaces of the waveguide region 111 may be free of the conductive oxide layers 120. In some embodiments, top surfaces of the conductive oxide layers 120 may be approximately coplanar or level. In some embodiments, the second conductive oxide layer 120B is separated from the waveguide region 111 by a distance D2 in the range of about 1 nm to about 100 μm, though other distances are possible. In some cases, forming conductive oxide layers 120 over a larger surface area and having a greater thickness can reduce resistance of a phase shifter 210.

Embodiments may achieve advantages. The techniques described herein allow for the formation of optical phase shifters and optical modulators having improved efficiency, improved bandwidth, and improved flexibility. By forming conductive oxide layers on a phase shifter, the resistance of the phase shifter can be reduced. The resistance of the P-N junction in a phase shifter can be reduced by using conductive oxide layers as described herein. Reducing resistance can also reduce transmission loss of the transmission line structure of the phase shifter. The conductive oxide layers can also facilitate control of the carrier distribution within a phase shifter, which can allow for improved control of the index of refraction. In some cases, the techniques described herein can improve the electro-optical S21 (“EOS21”) efficiency measure of an optical modulator. Various configurations of phase shifters and conductive oxide layers may be utilized.

In an embodiment, a structure includes a first p-type region over a substrate; a second p-type region against the first p-type region, wherein the second p-type region is more heavily doped than the first p-type region; a first n-type region against the first p-type region, wherein a portion of the first n-type region and a portion of the first p-type region collectively form a waveguide region; a second n-type region against the first n-type region, wherein the second n-type region is more heavily doped than the first n-type region; a first conductive oxide layer on the first p-type region; and a second conductive oxide layer on the first n-type region. In an embodiment, the first conductive oxide layer and the second conductive oxide layer include at least one of indium tin oxide (ITO), strontium titanate (SrTiO3), barium titanate (BaTiO3), zinc oxide (ZnO), copper oxide (CuO), nickel oxide (NiO), or hydrogen-doped indium oxide (IHO). In an embodiment, the first conductive oxide layer has a first thickness in the range of 1 nm to 500 nm, and the second conductive oxide layer has a second thickness in the range of 1 nm to 500 nm. In an embodiment, the first conductive oxide layer and the second conductive oxide layer extend on top surfaces of the waveguide region. In an embodiment, the first conductive oxide layer directly contacts a sidewall of the second p-type region. In an embodiment, the first conductive oxide layer extends continuously over a top surface of the second p-type region. In an embodiment, the second conductive oxide layer is physically separated from the first conductive oxide layer. In an embodiment, the structure includes a first contact on the second p-type region and a second contact on the second n-type region.

In an embodiment, a device includes a first phase shifter over a substrate, including: a first p-type region and a first n-type region; a first P-N junction between the first p-type region and the first n-type region; and a metal oxide material on the first p-type region and on the first n-type region, wherein the first P-N junction is free of the metal oxide material; and a waveguide over the substrate, wherein the waveguide is optically coupled to the first phase shifter. In an embodiment, the first P-N junction is a lateral P-N junction (LPN). In an embodiment, the first P-N junction is a vertical P-N junction (VPN). In an embodiment, the metal oxide material covers a top surface of the first P-N junction. In an embodiment, top surfaces of the first P-N junction and the metal oxide material are level. In an embodiment, the device includes a second phase shifter over the substrate, wherein the waveguide is optically coupled to the second phase shifter, wherein the second phase shifter includes: a second p-type region and a second n-type region; a second P-N junction between the second p-type region and the second n-type region; and the metal oxide material on the second p-type region and on the second n-type region, wherein the second P-N junction is free of the metal oxide material. In an embodiment, the metal oxide material on the first n-type region is separated from the first P-N junction by a distance in the range of 1 nm to 100 μm.

In an embodiment, a method includes forming an active layer material over a substrate; patterning the active layer material to form a phase shifter structure; implanting p-type dopants into the phase shifter structure to form a first p-type region; implanting n-type dopants into the phase shifter structure to form a first n-type region adjacent the first p-type region; forming a first conductive oxide layer on the first p-type region; and forming a second conductive oxide layer on the first n-type region. In an embodiment, the first p-type region extends over the first n-type region. In an embodiment, the method includes forming contacts on the first conductive oxide layer and on the second conductive oxide layer. In an embodiment, a height above the substrate of a top surface of the first conductive oxide layer is greater than a height above the substrate of a top surface of the phase shifter structure. In an embodiment, the method includes forming a waveguide over the substrate, wherein the waveguide is optically coupled to the phase shifter structure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A structure comprising:
a first p-type region over a substrate;
a second p-type region against the first p-type region, wherein the second p-type region is more heavily doped than the first p-type region;
a first n-type region against the first p-type region, wherein a portion of the first n-type region and a portion of the first p-type region collectively form a waveguide region;
a second n-type region against the first n-type region, wherein the second n-type region is more heavily doped than the first n-type region;
a first conductive oxide layer on the first p-type region; and
a second conductive oxide layer on the first n-type region.

2. The structure of claim 1, wherein the first conductive oxide layer and the second conductive oxide layer comprise at least one of indium tin oxide (ITO), strontium titanate (SrTiO3), barium titanate (BaTiO3), zinc oxide (ZnO), copper oxide (CuO), nickel oxide (NiO), or hydrogen-doped indium oxide (IHO).

3. The structure of claim 1, wherein the first conductive oxide layer has a first thickness in the range of 1 nm to 500 nm, wherein the second conductive oxide layer has a second thickness in the range of 1 nm to 500 nm.

4. The structure of claim 1, wherein the first conductive oxide layer and the second conductive oxide layer extend on top surfaces of the waveguide region.

5. The structure of claim 1, wherein the first conductive oxide layer directly contacts a sidewall of the second p-type region.

6. The structure of claim 1, wherein the first conductive oxide layer extends continuously over a top surface of the second p-type region.

7. The structure of claim 1, wherein the second conductive oxide layer is physically separated from the first conductive oxide layer.

8. The structure of claim 1 further comprising a first contact on the second p-type region and a second contact on the second n-type region.

9. A device comprising:
a first phase shifter over a substrate, comprising:
a first p-type region and a first n-type region;
a first P-N junction between the first p-type region and the first n-type region; and
a metal oxide material on the first p-type region and on the first n-type region, wherein the first P-N junction is free of the metal oxide material; and
a waveguide over the substrate, wherein the waveguide is optically coupled to the first phase shifter.

10. The device of claim 9, wherein the first P-N junction is a lateral P-N junction (LPN).

11. The device of claim 9, wherein the first P-N junction is a vertical P-N junction (VPN).

12. The device of claim 11, wherein the metal oxide material covers a top surface of the first P-N junction.

13. The device of claim 9, wherein top surfaces of the first P-N junction and the metal oxide material are level.

14. The device of claim 9 further comprising a second phase shifter over the substrate, wherein the waveguide is optically coupled to the second phase shifter, wherein the second phase shifter comprises:
a second p-type region and a second n-type region;
a second P-N junction between the second p-type region and the second n-type region; and
the metal oxide material on the second p-type region and on the second n-type region, wherein the second P-N junction is free of the metal oxide material.

15. The device of claim 9, wherein the metal oxide material on the first n-type region is separated from the first P-N junction by a distance in the range of 1 nm to 100 μm.

16. A method comprising:
forming an active layer material over a substrate;
patterning the active layer material to form a phase shifter structure;
implanting p-type dopants into the phase shifter structure to form a first p-type region;
implanting n-type dopants into the phase shifter structure to form a first n-type region adjacent the first p-type region;
forming a first conductive oxide layer on the first p-type region; and
forming a second conductive oxide layer on the first n-type region.

17. The method of claim 16, wherein the first p-type region extends over the first n-type region.

18. The method of claim 16 further comprising forming contacts on the first conductive oxide layer and on the second conductive oxide layer.

19. The method of claim 16, wherein a height above the substrate of a top surface of the first conductive oxide layer is greater than a height above the substrate of a top surface of the phase shifter structure.

20. The method of claim 16 further comprising forming a waveguide over the substrate, wherein the waveguide is optically coupled to the phase shifter structure.
